(19) United States
(12) Patent Application Publication
(10) Pub. No.: US 2025/0080845 A1
(43) Pub. Date: Mar. 6, 2025

(54) ELECTRONIC DEVICE AND LENS CONTROL METHOD OF OPTICAL IMAGE STABILIZATION THEREOF

(71) Applicant: ASUSTeK COMPUTER INC., Taipei City (TW)

(72) Inventors: Jo-Fan Wu, Taipei City (TW); Wen-Ling Lin, Taipei City (TW)

(73) Assignee: ASUSTeK COMPUTER INC., Taipei City (TW)

(21) Appl. No.: 18/751,357

(22) Filed: Jun. 24, 2024

(30) Foreign Application Priority Data
Aug. 30, 2023 (TW) 112132765

(51) Int. Cl. H04N 23/68

(52) U.S. Cl. CPC H04N 23/687; H04N 23/6812

(57) ABSTRACT

An electronic device and a lens control method of optical image stabilization thereof are provided. The method is adapted to the electronic device. The electronic device includes a lens, and the method includes the following steps. An accumulated deviation angle of the electronic device is obtained according to a driving signal. A compensation angle is determined according to the accumulated deviation angle of the electronic device. The lens is controlled to move according to compensation angle.

### CROSS-REFERENCE TO RELATED APPLICATION

This application claims the priority benefit of Taiwan application serial no. 112132765, filed on Aug. 30, 2023. The entirety of the above-mentioned patent application is hereby incorporated by reference herein and made a part of this specification.

### BACKGROUND

### Technical Field

The application relates to an electronic device and a lens control method of optical image stabilization thereof.

### Description of Related Art

With the advancement of technology, electronic devices with camera functions have become prevalent in modern people's lives. In order to improve the problem of blurry images captured by electronic devices in a vibrating state, the image stabilization function (also known as anti-shake function or anti hand shaking function) was developed to improve image quality.

Traditionally, the Optical Image Stabilization (OIS) system will refer to the accumulated lens position for compensation to control the tendency of the movable lens to return to the optical center, thereby compensating for vibrations from all directions at any time. In this case, when the exposure time is long or when multiple frames of continuous images need to be synthesized, the continuous behavior of the lens tending to return to the optical center in the traditional OIS system will cause the image sensor to appear motion blur during the photosensitivity period. Generally speaking, in order to avoid motion blur in images captured by the OIS system, fixed devices (such as a tripod) are often used to fix the shooting device. However, these fixed devices are inconvenient to carry and are easily limited by the venue.

### SUMMARY

A lens control method of optical image stabilization is provided. The method is adapted to an electronic device. The electronic device includes a lens, and the method includes the following steps. An accumulated deviation angle of the electronic device is obtained according to a driving signal. A compensation angle is determined according to the accumulated deviation angle of the electronic device. The lens is controlled to move according to compensation angle.

An electronic device is also provided. The electronic device includes a motion sensor, a lens, a driving device, and a controller. The driving device is configured to move the lens. The controller is coupled to the motion sensor and the driving device and is configured to: obtaining an accumulated deviation angle of the electronic device according to a driving signal through the motion sensor; determining a compensation angle according to the accumulated deviation angle of the electronic device; and controlling the lens to move according to the compensation angle through the driving device.

Based on the above, in the embodiment of the present invention, the accumulated deviation angle of the electronic device is obtained according to the driving signal (such as a shooting signal). Therefore, during the period when the image sensor performs exposure according to the shooting signal, the compensation angle is determined based on the accumulated deviation angle of the electronic device without reference to the lens position sensed by the lens position sensor. Then, the lens movement is controlled according to the compensation angle to avoid the compensation effect of the lens position sensor continuing to return to the positive position. Based on this, the tendency of the lens to return to the optical center during the exposure process can be suppressed, thereby avoiding dynamic blur and improving the clarity of images captured during longer exposure periods.

### BRIEF DESCRIPTION OF THE DRAWINGS

FIG. 1 is a schematic diagram of the electronic device according to an embodiment of the present invention.

FIG. 2 is a schematic diagram of the optical image stabilization system of the electronic device according to an embodiment of the present invention.

FIG. 3 is a flow chart of the lens control method of optical image stabilization according to an embodiment of the present invention.

FIG. 4 is a flow chart of the lens control method of optical image stabilization according to an embodiment of the present invention.

### DESCRIPTION OF THE EMBODIMENTS

Reference will now be made in detail to the exemplary embodiments of the present invention, examples of which are illustrated in the accompanying drawings. Wherever possible, the same component numbers are used in the drawings and descriptions to refer to the same or similar parts. The examples are only part of the present invention and do not reveal all possible implementations of the present invention. To be more precise, these examples are only examples of devices and methods within the scope of claims of the present invention.

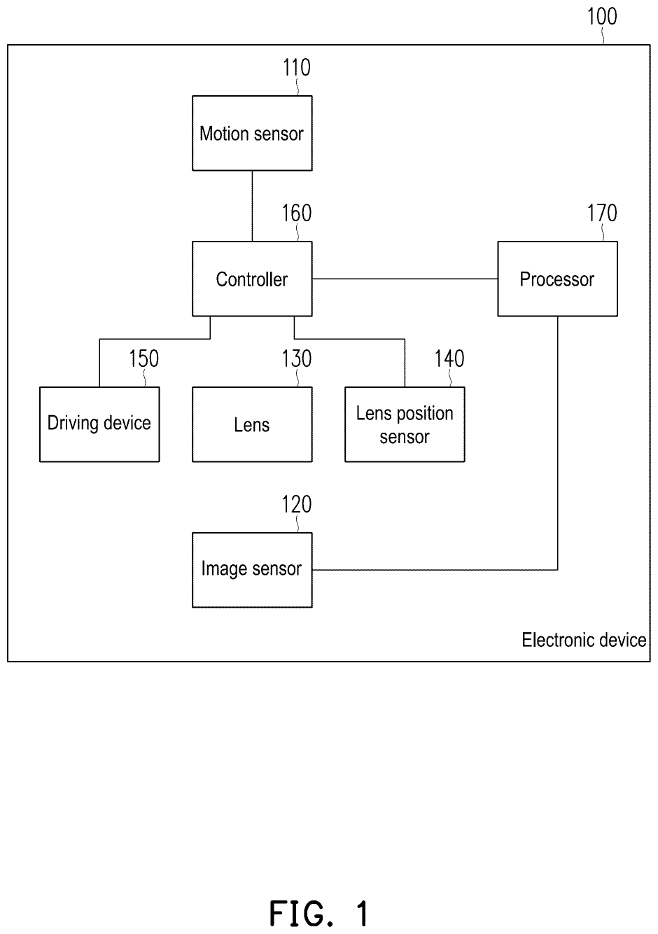

Referring to FIG. 1, the electronic device 100 may be, for example, a smart phone, a digital camera, a tablet computer, a game console, an electronic wearable device or a photography device and other electronic devices with image capturing functions, and the type of the electronic device 100 is not limited thereto. It should be noted that the electronic device 100 has an Optical Image Stabilization (OIS) function. The electronic device 100 may include a motion sensor 110, an image sensor 120, a lens 130, a lens position sensor 140, a driving device 150, a controller 160, and a processor 170. That is, the electronic device 100 has related components of the OIS function.

The motion sensor 110 is used to sense the vibration and movement of the electronic device 100. The motion sensor 110 may include an accelerometer, a gyroscope or an angle sensor, etc. The motion sensing data generated by the motion sensor 110 includes an angle sensing data, an angular velocity sensing data, or a linear acceleration sensing data. For example, the gyroscope can be used to sense the angular velocity generated by the shaking of the electronic device 100; the acceleration sensor can be used to sense the linear acceleration generated by the shaking of the electronic device 100.

The image sensor 120 is used to provide image sensing function. The image sensor 120 may include photosensitive elements, such as Charge Coupled Device (CCD), Complementary Metal-Oxide Semiconductor (CMOS) elements or other elements, which are not limited in the present invention.

The lens 130 can collect imaging light on the image sensor 120 to achieve the purpose of capturing images. The lens 130 may include an optical lens and a lens base, etc. The lens 130 is movable. In some embodiments, the lens 130 may include a micro gimbal stabilizer structure. In some embodiments, the lens 130 may be translated along different axes. In some embodiments, the optical axis direction of the lens 130 can be changed, that is, the tilt angle of the lens 130 can be changed.

The lens position sensor 140 is used to sense the lens position of the lens 130 in real time, and may include, for example, one or more hall elements. For example, the lens position sensor 140 can be used to sense the position of the lens 130 in different axial directions or the tilt angle of the lens 130 in real time.

The driving device 150 can move the lens 130 according to a control signal of the controller 160. The driving device 150 is, for example, a Voice Coil Motor (VCM), Micro Electro-Mechanical Systems (MEMS) or Shape Memory Alloys (SMA), etc.

The controller 160 is coupled to the motion sensor 110, the lens position sensor 140, the driving device 150, the controller 160, and the processor 170 which is, for example, a programmable general-purpose or special-purpose microprocessor, Digital Signal Processor (DSP), programmable controller, Application Specific Integrated Circuits (ASIC), Programmable Logic Device (PLD) or other similar devices or combinations thereof that can load and execute software/firmware code. In some embodiments, the controller 160 may be configured to perform various steps of the method of the embodiment.

The processor 170 is coupled to the controller 160 and the image sensor 120, which is, for example, an application processor (AP), a programmable general-purpose or special-purpose microprocessor, DSP, Image Signal Processor (ISP) or other similar devices, integrated circuits or combinations thereof. The processor 170 can control the action of the image sensor 120. Moreover, the processor 170 can analyze the image data captured by the image sensor 120 to determine camera parameters (such as exposure time or lens focal length, etc.).

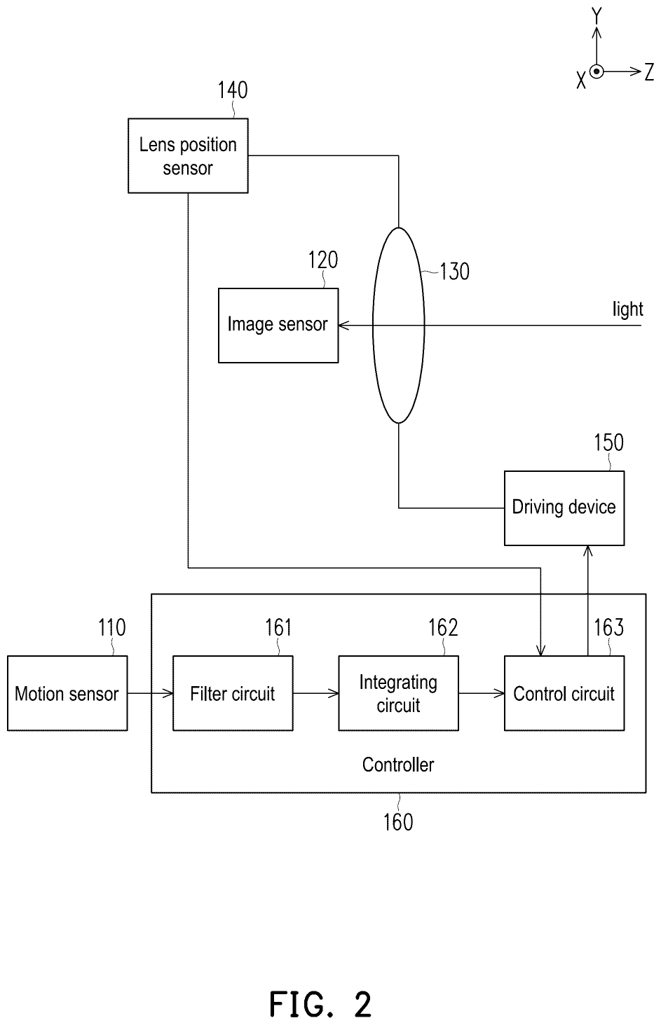

Referring to FIG. 2, in the embodiment of the present invention, the driving device 150 is connected to the lens 130. The controller 160 can control the driving device 150 to adjust the position of the lens 130 in different axial directions (such as the X-axis, Y-axis or Z-axis in the figure) or the tilt angle of the lens 130. Therefore, the image sensed by the image sensor 120 can remain stable under various motion conditions such as hand shaking, head shaking, vehicle vibration, etc. In more detail, when the OIS function is enabled, when the electronic device 100 shakes, the controller 160 can receive the motion sensing data from the motion sensor 110. After that, the controller 160 can determine the way to move the lens 130 according to the motion sensing data. Therefore, the controller 160 can control the driving device 150 to adjust the position or the tilt angle of the lens 130 on different axes to achieve vibration compensation, thereby improving image blur caused by vibration.

As shown in FIG. 2, in some embodiments, the controller 160 may include a filter circuit 161, an integrating circuit 162, and a control circuit 163. The filter circuit 161 is coupled to the motion sensor 110, and the filter circuit 161 can filter the motion sensing data provided by the motion sensor 110. In the embodiment, the integrating circuit 162 is coupled between the filter circuit 161 and the control circuit 163, and the motion sensing data provided by the motion sensor 110 is the angular velocity sensing data or the linear acceleration sensing data. The integrating circuit 162 integrates the motion sensing data provided by the motion sensor 110 and performs necessary calculations to generate the accumulated deviation angle of the electronic device 100. In another embodiment, when the motion sensing data provided by the motion sensor 110 is the angular velocity sensing data, the integrating circuit 162 may not be needed to perform the integration operation. The control circuit 163 obtains the accumulated deviation angle of the electronic device 100 from the integrating circuit 162, and determines the compensation angle according to the accumulated deviation angle of the electronic device 100. Therefore, the control circuit 163 can control the driving device 150 to drive the lens 130 to translate or tilt according to the above compensation angle.

It should be noted that in this embodiment of the present invention, when the controller 160 receives a driving signal, the controller 160 enters a specific optical anti-shake mode. When operating in the specific optical anti-shake mode, the compensation angle is determined based on the accumulated deviation angle of the electronic device 100 and may not be determined with reference to the lens position sensed by the lens position sensor 140, so as to control the movement of the lens 130 according to the compensation angle. Therefore, when operating in the specific optical anti-shake mode, the compensation angle used to control the movement of the lens 130 has nothing to do with the lens position sensed by the lens position sensor 140. In some embodiments, when the image sensor 120 receives a shooting signal, the image sensor 120 begins to perform exposure to capture a shooting frame. That is, the image sensor 120 starts to capture at least one frame of image in response to the driving signal. At this time, the controller 160 determines the compensation angle according to the accumulated deviation angle of the electronic device 100. In this way, the relative spatial direction relationship between the imaging of the lens 130 on the image sensor 120 and the scene objects may be substantially fixed, and the tendency of the lens 130 to return to the optical center in the optical image stabilization function may be suppressed. Therefore, even if the user uses a long exposure time to capture an image, the captured image can be clearly formed, thereby improving the safety shutter level of the electronic device 100.

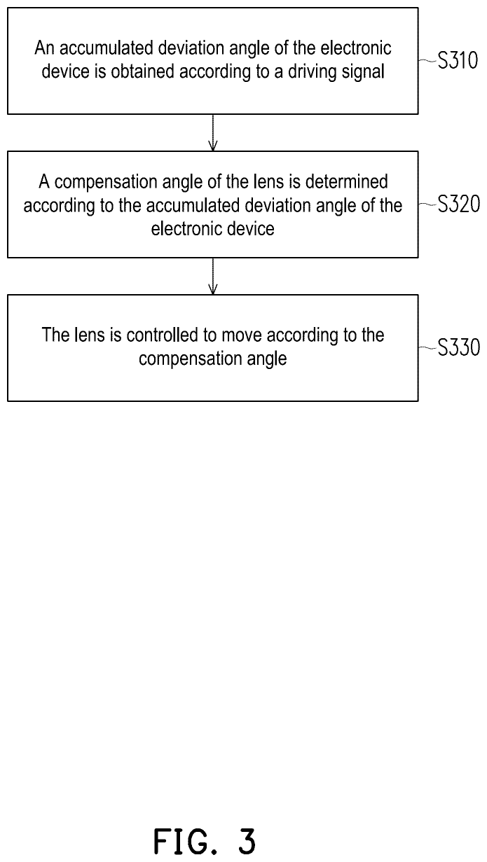

Referring to FIG. 3, the method of the embodiment can be executed by the electronic device 100 of FIG. 1 and FIG. 2. The details of each step in FIG. 3 will be described below with reference to the components shown in FIG. 1 and FIG. 2.

In step S310, the controller 160 obtains the accumulated deviation angle of the electronic device 100 according to a driving signal. The above-mentioned driving signal is, for example, a shooting signal or a shooting mode setting signal generated according to user instructions. Alternatively, the above-mentioned driving signal is, for example, a driving signal generated by opening a specific application. In details, the controller 160 can obtain a motion sensing data provided by the motion sensor 110, and determine the accumulated deviation angle of the electronic device 100 according to the motion sensing data. For example, the controller 160 can obtain the accumulated deviation angle of the electronic device 100 by integrating the angular velocity sensing data provided by the gyroscope. In some embodiments, the accumulated deviation angle of the electronic device 100 may include at least one of a yaw angle, a roll angle, and a pitch angle relative to the three axes (i.e., the X-axis, the Y-axis, and the Z-axis).

In an embodiment, when the processor 170 receives a shooting instruction issued by the user through a button or touch screen, it sends a shooting signal to the image sensor 120 to control the image sensor 120 to start the exposure process.

In step S320, the controller 160 determines the compensation angle for the lens 130 according to the accumulated deviation angle of the electronic device 100. Afterwards, in step S330, the controller 160 controls the movement of the lens 130 through the driving device 150 according to the compensation angle. In details, the controller 160 can determine the compensation movement amount or the compensation tilt amount of the lens 130 according to the compensation angle, and control the translation or tilt of the lens 130 through the driving device 150 according to the compensation movement amount or the compensation tilt amount.

It should be noted that in some embodiments, when receiving a driving signal, the controller 160 enters a first optical anti-shack mode. During operation in the first optical anti-shack mode, the lens position sensed by the lens position sensor 140 does not affect the compensation angle of the lens 130. The compensation angle of the lens 130 only depends on the accumulated deviation angle of the electronic device 100. For example, the driving signal may be a shooting signal. After the controller 160 receives the shooting signal, during the period when the image sensor 120 captures the shooting image, the continuous compensation effect of vibration compensation based on the sensing result of the lens position sensor 140 is suppressed. In this way, the lens 130 can be aimed at the shooting object in the scene to make the shooting image clear.

In more detail, in some embodiments, when the processor 170 receives the shooting instruction from the user, it sends the shooting signal to the controller 160. The controller 160 determines an initial angular position of the lens 130 relative to a reference direction according to the shooting signal. The above-mentioned reference direction includes any one of the three axis directions of a reference coordinate system (i.e., X-axis direction, Y-axis direction, and Z-axis direction). It should be noted that issuing the shooting instruction is an application example of triggering the technical effect, and the triggering method is not limited thereto.

Afterwards, during entering the first optical anti-shack mode, the controller 160 determines the target angular position of the lens 130 according to the above initial angular position and the above compensation angle. In some embodiments, the target angular position of the lens 130 may include at least one of the yaw angle, roll angle, and pitch angle relative to the three axes (i.e., X-axis, Y-axis, and Z-axis) in the reference coordinate system. The reference coordinate system may be a device coordinate system of the electronic device 100.

Therefore, the controller 160 can control the driving device 150 to move the lens 130 according to the target angular position. In some embodiments, the controller 160 can determine the movement amount of the lens 130 on three axes (i.e., X-axis, Y-axis, and Z-axis) according to the target angular position of the lens 130. Alternatively, in some embodiments, the controller 160 may determine the tilt angle of the lens 130 according to the target angular position of the lens 130.

For example, assume that the start time of the first optical anti-shack mode triggered by the driving signal is tₛₜₐᵣₜ, and the end time of the first optical anti-shack mode is t_{end}. And assuming that the external influence received by the electronic device 100 is a simple rotational motion relative to the center of the lens, the target angular position θ_{LensToPhone}(tᵢ) of the lens 130 during an actual shooting period satisfies the following Formula (1) and Formula (2).

$${θ}_{LensToPhone} ( {t}_{i} ) = {θ}_{LensToPhone} ( {t}_{start} ) + {\int }_{{t}_{start}}^{{t}_{i}} {ω}_{LensToPhone} ( t ) dt , \qquad Formula ( 1 )$$

$${t}_{start} \leq {t}_{i} \leq {t}_{end}$$

$${θ}_{LensToPhone} ( {t}_{i} ) = {θ}_{LensToPhone} ( {t}_{start} ) - {\int }_{{t}_{start}}^{{t}_{i}} {ω}_{PhoneToWorld} ( t ) dt \qquad Formula ( 2 )$$

Wherein, ω(t) represents the relative angular velocity at t instant; tᵢ represents the time point between the start time and the end time of the first optical anti-shake mode; ∫ₜ_{ₛₜₐᵣₜ}^{t}^{ᵢ}ω_{PhoneToWorld}(t)dt represents the accumulated deviation angle of the electronic device 100 at time tᵢ; ∫ₜ_{ₛₜₐᵣₜ}^{t}^{ᵢ}ω_{LensToPhone}(t)dt represents the accumulated deviation angle of the lens according to the electronic device 100 at time tᵢ; θ_{LensToPhone}(tₛₜₐᵣₜ) represents the initial angular position of the lens 130.

Therefore, the controller 160 can determine the movement amount or tilt amount of the lens 130 according to the target angular position θ_{LensToPhone}(tᵢ), and control the translation or tilt of the lens 130 through the driving device 150 according to the movement amount or tilt amount.

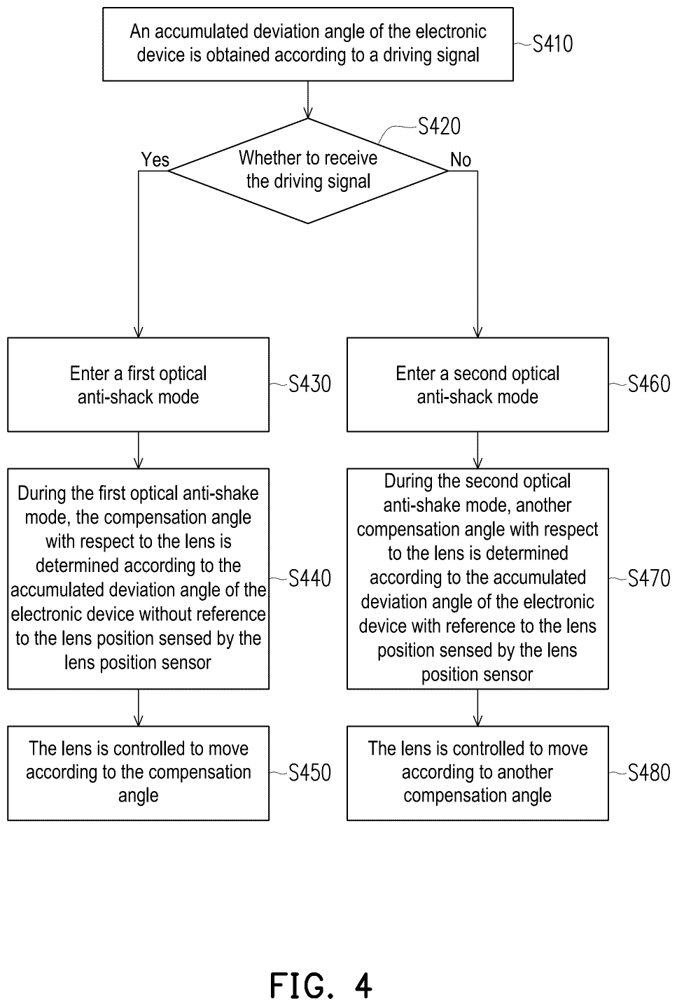

Referring to FIG. 4, the method of the embodiment can be executed by the electronic device 100 of FIG. 1 and FIG. 2. The details of each step in FIG. 4 will be described below with reference to the components shown in FIG. 1 and FIG. 2.

In step S410, the controller 160 determines the accumulated deviation angle of the electronic device 100 through the motion sensor 110 according to a driving signal. In step S420, the controller 160 and the image sensor 120 respectively determine whether a driving signal is received. when the determination in step S420 is Yes, in step S430, the controller 160 enters a first optical anti-shack mode. That is, when the controller 160 receives the shooting signal, the controller 160 enters the first optical anti-shack mode. In step S440, during the first optical anti-shack mode, the controller 160 determines the compensation angle with respect to the lens 130 according to the accumulated deviation angle of the electronic device 100 without reference to the lens position sensed by the lens position sensor 140. In step S450, the controller 160 controls the movement of the lens 130 through the driving device 150 according to the compensation angle. The operations from step S410 to step S450 may refer to the aforementioned embodiments and will not be described again here.

When the determination in step S420 is No, in step S460, the controller 160 enters a second optical anti-shack mode. In step S470, during the second optical anti-shack mode, the controller 160 determines another compensation angle with respect to the lens according to the accumulated deviation angle of the electronic device and with reference to the lens position sensed by the lens position sensor. In step S480, the controller 160 controls the lens 130 to move according to another compensation angle.

In some embodiments, when the driving signal is the shooting signal, that is, the controller 160 enters the first optical anti-shack mode or the second optical anti-shack mode depending on whether it receives the shooting signal. Therefore, when the determination in step S420 is No, it means that the electronic device 100 is still operating in a photo preview mode and has not received a shooting instruction from the user. Therefore, when operating in the photo preview mode, the image sensor 120 can provide the preview image to the processor 170. The processor 170 can analyze the preview image to determine an image auxiliary information, such as lens focal length, object distance of the object being photographed in the image, exposure time and ambient color temperature, etc. According to the image auxiliary information generated by the processor 170 and the compensation angle based on the accumulated deviation angle of the electronic device 100, the controller 160 can determine the movement amount or tilt angle of the lens 130. In addition, when operating in the photo preview mode, the controller 160 determines another compensation angle according to the accumulated deviation angle of the electronic device 100 and the lens position sensed by the lens position sensor 140. That is to say, when operating in the photo preview mode, another compensation angle determined by the controller 160 is related to the lens position sensed by the lens position sensor 140, and the lens 130 tends to return to the optical center. In this way, the viewing experience of the photo preview mode can be taken into account.

For example, assuming that the start time of the first frame according to the driving signal is tₛₜₐᵣₜ and the end time of the last frame is t_{end}, then the target angle position θ_{LensToPhone}(tᵢ) of the lens 130 during an actual shooting period and the photo preview mode satisfies the following formula (3).

$${θ}_{LensToPhone} ( {t}_{i} ) = \{ \begin{matrix}{θ}_{LensToPhone} ( {t}_{0} ) - {\int }_{{t}_{0}}^{{t}_{i}} {ω}_{PhoneToWorld} ( t ) dt + {θ}_{hall} ( {H}_{i} ) , & {t}_{0} \leq {t}_{i} \leq {t}_{start} \\ {θ}_{LensToPhone} ( {t}_{start} ) - {\int }_{{t}_{start}}^{{t}_{i}} {ω}_{PhoneToWorld} ( t ) dt , & {t}_{start} \leq {t}_{i} \leq {t}_{end} \\ {θ}_{LensToPhone} ( {t}_{end} ) - {\int }_{{t}_{end}}^{{t}_{i}} {ω}_{PhoneToWorld} ( t ) dt + {θ}_{hall} ( {H}_{i} ) , & {t}_{end} \leq {t}_{i}\end{matrix} \qquad Formula ( 3 )$$

Wherein, ω(t) represents the relative angular velocity at t instant; tᵢ represents the time point; ∫ₜ_{₀}^{t}^{ᵢ}ω_{PhoneToWorld}(t)dt, ∫ₜ_{ₛₜₐᵣₜ}^{t}^{ᵢ}ω_{PhoneToWorld}(t)dt and ∫ₜ_{_{end}}^{t}^{ᵢ}ω_{PhoneToWorld}(t)dt respectively represent the accumulated deviation angle of the electronic device 100 at time tᵢ; θₕₐₗₗ(Hᵢ) represents a back-alignment compensation angle calculated by the lens position sensed by the lens position sensor 140 and the feedback of the controller 160 at time tᵢ; θ_{LensToPhone}(tₛₜₐᵣₜ) represents the initial angular position of the lens 130 relative to the electronic device 100 during the actual shooting period.

According to Formula (3), in the photo preview mode, in addition to the accumulated deviation angle, the lens position sensor 140 can be used to determine another positive compensation angle θₕₐₗₗ(Hᵢ) according to the sensed lens position at time tᵢ. The controller 160 determines another compensation angle according to the accumulated deviation angle of the electronic device 100 and another positive compensation angle θₕₐₗₗ(Hᵢ). And the controller 160 determines the target angular position θ_{LensToPhone}(tᵢ) of the lens 130 according to another compensation angle.

In summary, in the embodiment of the present invention, during the period when the technical mode is activated according to the driving signal, the compensation angle is determined based on the accumulated deviation angle of the electronic device without reference to the lens position sensed by the lens position sensor, and the lens movement is controlled according to the compensation angle. Based on this, the tendency of the lens to return to the optical center during the exposure process can be suppressed, thereby avoiding dynamic blur and improving the clarity of the captured image during the exposure period. And it can greatly improve the efficiency of the optical anti-shack mechanism.

Although the present invention has been disclosed with reference to the embodiments, it is not intended to limit the present invention. Those skilled in the art may make some modifications and refinements within the spirit and scope of the present invention. Therefore, the scope of protection of the present invention shall be determined by the appended claims.

What is claimed is:

1. A lens control method of optical image stabilization, adapted for an electronic device, the electronic device comprises a lens, the method comprising:
obtaining an accumulated deviation angle of the electronic device according to a driving signal;
determining a compensation angle according to the accumulated deviation angle of the electronic device; and
controlling the lens to move according to the compensation angle.

2. The lens control method of optical image stabilization according to claim 1, wherein the method further comprises:
obtaining an initial angular position of the lens relative to a reference direction according to the driving signal; and
determining a target angular position of the lens according to the initial angular position and the compensation angle.

3. The lens control method of optical image stabilization according to claim 2, wherein the step of controlling the lens to move according to compensation angle comprises:
controlling a driving device to move the lens according to the target angular position.

4. The lens control method of optical image stabilization according to claim 1, wherein the step of obtaining the accumulated deviation angle of the electronic device according to the driving signal comprises:
obtaining a motion sensing data provided by a motion sensor, wherein the motion sensing data comprises an angle sensing data or an angular velocity sensing data; and
determining the accumulated deviation angle of the electronic device according to the motion sensing data.

5. The lens control method of optical image stabilization according to claim 4, wherein the step of determining the accumulated deviation angle of the electronic device according to the motion sensing data comprises:
filtering the motion sensing data through a filter circuit.

6. The lens control method of optical image stabilization according to claim 4, wherein the step of determining the accumulated deviation angle of the electronic device according to the motion sensing data comprises:
integrating the motion sensing data through an integrating circuit to generate the accumulated deviation angle when the motion sensing data is the angular velocity sensing data.

7. An electronic device with optical image stabilization, comprising:
a motion sensor;
a lens;
a driving device, configured to move the lens; and
a controller, coupled to the motion sensor, the lens position sensor and the driving device, is configured to:
obtaining an accumulated deviation angle of the electronic device according to a driving signal through the motion sensor;
determining a compensation angle according to the accumulated deviation angle of the electronic device; and
controlling the lens to move according to the compensation angle through the driving device.

8. The electronic device according to claim 7, wherein the controller is configured to:
obtaining an initial angular position of the lens relative to a reference direction according to the driving signal; and
determining a target angular position of the lens according to the initial angular position and the compensation angle.

9. The electronic device according to claim 8, wherein the controller is configured to:
controlling the driving device to move the lens according to the target angular position.

10. The electronic device according to claim 7, wherein the controller is configured to:
obtaining a motion sensing data provided by the motion sensor, wherein the motion sensing data comprises an angle sensing data, an angular velocity sensing data or a linear acceleration sensing data; and
determining the accumulated deviation angle of the electronic device according to the motion sensing data.

11. The electronic device according to claim 10, wherein the controller comprises a filter circuit, the filter circuit filters the motion sensing data.

12. The electronic device according to claim 10, wherein the controller comprises an integrating circuit, when the motion sensing data is the angular velocity sensing data or the linear acceleration sensing data, the integrating circuit integrates the motion sensing data and performs necessary calculations to generate the accumulated deviation angle.

13. The electronic device according to claim 10, wherein the driving signal comprises a shooting signal, the electronic device further comprises an image sensor, the image sensor starts capturing at least one frame of image in response to the driving signal.
